(19) United States
(12) Patent Application Publication
(10) Pub. No.: US 2009/0112572 A1
(43) Pub. Date: Apr. 30, 2009

(54) SYSTEM AND METHOD FOR INPUT OF TEXT TO AN APPLICATION OPERATING ON A DEVICE

(76) Inventor: Karl Ola THORN, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/928,162

(22) Filed: Oct. 30, 2007

(51) Int. Cl. G06F 9/45

(52) U.S. Cl. 704/3

(57) ABSTRACT

A device comprise an a display screen and an audio circuit for generating an audio signal representing spoken words uttered by the user. A processor executes a first application, a second application, and a text mark-up object. The first application may render a depiction of text on the display screen. The text mark-up object may: i) receiving at least a portion of the audio signal representing spoken words uttered by the user; ii) performing speech recognition to generate a text representation of the spoken words uttered by the user; iii) determining a selected text segment, and iv) performing an input function to input the selected text segment to the second application. The selected text segment may be text which corresponds to both a portion of the depiction of text on the display screen and the text representation of the spoken words uttered by the user.

### TECHNICAL FIELD OF THE INVENTION

The present invention relates to input of text to an application operating on a device, and more particularly, to facilitate the selection, marking, and pasting of a depiction of text rendered on a display screen to an application operating on the device.

### DESCRIPTION OF THE RELATED ART

Computer operating systems such as the Windows® series of operating systems available from Microsoft Corporation have, for many years, included a clipboard functions to enable selecting, marking, cut/copy, and pasting of character strings between applications.

In general, a user, utilizing a pointing device such as a mouse and/or various combinations of keys, may select and mark a character string in a first application. Thereafter, mouse (right click) menu choices or certain keys may be used for cutting or copying the marked character string to an electronic “clipboard”. Thereafter, when another application is active, the user may select a “paste” function to insert the character string from the “clipboard” into the active application.

More recently, contemporary mobile devices devices, including mobile telephones, portable data assistants (PDAs), and other mobile electronic devices often include embedded software applications in addition to traditional mobile telephony applications. Software applications that are commonly embedded on mobile devices include text based application such as a notes application, a contacts application, and/or word processor application.

As with traditional computer systems, operating systems present on contemporary mobile devices (such as Windows CE®) may included similar clip board functions. A challenge exists in that using the clip board function on a mobile device, and in particular, selecting and marking text on the small display screen of a mobile device—utilizing the limited user interface—which often lacks a pointing device can be cumbersome.

More recently, as costs associated with digital imaging circuitry have decreased, many portable devices further include embedded image capture circuitry (e.g. digital cameras) and a digital photo album, photo management application, or other system for storing and managing digital photographs within a database.

It has been proposed to utilize character recognition systems to enable a user of a portable device to “photograph” text utilizing the digital camera, initiate character recognition, and paste such recognized text into an active application. In support of this endeavor, various methods have been proposed for enabling a user to select text depicted within the photograph for character recognition and pasting into an active application.

One proposed method that can be implemented on a mobile device with a touch sensitive display screen involves the user drawing a “lasso” around the selected text utilizing a stylus or his/her finger. Another proposed method requires the user to perform “pan” and “zoom” functions so that only the selected text is visible on the display screen. Both proposed solutions have drawbacks related to accuracy of character recognition processes and drawbacks related to both accuracy and ease of use of the methods for selecting text for recognition.

What is needed is a portable device that includes systems which facilitate the selection, marking, and pasting of a depiction of text rendered on a display screen to an application operating on the mobile device in a manner that does not suffer the disadvantages of known systems. Further, what is needed is a portable device that includes systems which facilitate selection, marking and pasting of a depiction of text within a digital photograph image to an application operated on the mobile device that does not: i) suffer the inconveniences of known methods for text selection; and ii) does not suffer the inaccuracies of known character recognition systems.

### SUMMARY

A first aspect of the present invention comprises a device such as a PDA, mobile telephone, notebook computer, television, or other device comprising a display screen on which a still or motion video image may be rendered. The device further comprises an audio circuit for generating an audio signal representing spoken words uttered by the user. A processor executes a first application, a second application, and a text mark-up object which may be part of an embedded operating system.

The first application may render a depiction of text on the display screen. The text mark-up object may: i) receive at least a portion of the audio signal representing spoken words uttered by the user; ii) perform speech recognition to generate a text representation of the spoken words uttered by the user; iii) determine a selected text segment, and iv) perform an input function to input the selected text segment to the first or the second application. The selected text segment may be text which corresponds to both a portion of the depiction of text on the display screen and the text representation of the spoken words uttered by the user.

In one embodiment, the first application may be an application rendering a digital image including the depiction of text on the display screen. In such embodiment: i) the text mark-up object further performs character recognition on the depiction of text to generate a character string, and ii) the selected text segment may comprise text which corresponds to both a portion of the character string and the text representation of the spoken words uttered by the user.

In one sub embodiment, the mobile device may further comprising a digital camera. In such sub embodiment, the application may render an image captured by the digital camera in real time, thus operating as a view finder, as the image including the depiction of text on the display screen.

In another embodiment, the device may further comprise a digital photograph database storing a plurality of images. In such embodiment, the text mark-up object may further perform character recognition on text depicted in each image, and associate with each image, a character string corresponding to the text depicted therein. Such character recognition may be performed as a background operation, such as during a time period during which the processor would otherwise be idle.

In this embodiment: i) the first application may be an application rendering a digital image including the depiction of text on the display screen; and ii) determining the selected text segment comprising selecting the portion of the character string associated, in the database, with the image rendered on the display screen, which corresponds to the text representation of the spoken words uttered by the user.

In yet another embodiment, the selected text segment may correspond to the portion of the depiction of text on the display screen that is between a first text representation of spoken words uttered by the user and a second text representation of spoken words uttered by the user.

In all such embodiments, the text mark-up object may further drive rendering of a marking of the portion of the depiction of text on the display screen which corresponds to the selected text segment. Further, in all such embodiments, the text mark-up object may only perform the paste function upon detection of an input command which may be while rendering the marking on the display screen. The paste command may be an audio command uttered by the user and which text mark-up object detects within the audio signal utilizing speech recognition.

A second aspect of the present invention comprises a method of operating a mobile device to select and paste a selected text segment depicted on a display screen to an application. The method comprises: i) driving the first application to render a depiction of text on a display screen; ii) receiving at least a portion of an audio signal representing spoken words uttered by the user; iii) performing speech recognition to generate a text representation of the spoken words uttered by the user; iv) determining the selected text segment; and v) performing an input function to input the selected text segment to the second application. Again, the selected text segment being text which corresponds to both a portion of the depiction of text on the display screen and the text representation of the spoken words uttered by the user

In one embodiment, the first application may be an application rendering a digital image including the depiction of text on the display screen; In such embodiment, the method may further comprise performing a character recognition process on the depiction of text to generate a character string. As such, the selected text segment comprises text which corresponds to both a portion of the character string and the text representation of the spoken words uttered by the user.

In another embodiment, the first application is an application rendering a digital image including the depiction of text on the display screen wherein the digital image is obtained from a database storing a plurality of digital images. In such embodiment, the method may further comprise: i) receiving at least a portion of an audio signal representing spoken words uttered by the user; ii) performing speech recognition to generate a text representation of the words uttered by the user; and iii) determining the selected text segment by selecting the portion of the character string associated, in the database, with the image rendered on the display screen, which corresponds to the text representation of the spoken words uttered by the user. The character string associated, in the database, with the image rendered on the display screen is generated and written to the database during a character recognition process performed as a background operation at time prior to rendering the determining the selected text segment.

In yet another embodiment, the selected text segment may be text which corresponds to the portion of the depiction of text on the display screen that is between a first text representation of spoken words uttered by the user and a second text representation of spoken words uttered by the user.

Again, in all such embodiments, the method may further include rendering a marking of the portion of the depiction of text on the display screen which corresponds to the selected text segment. Further, in all such embodiments, the paste function may be performed only upon detection of an input command which may be while rendering the marking on the display screen. The paste command may be an audio command uttered by the user and which is detected within the audio signal utilizing speech recognition.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a diagram representing an exemplary device including a system for selecting, marking, and pasting of a selected text segment to an application in accordance with one embodiment of the present invention;

FIG. 2 is a diagram representing the exemplary device depicted in FIG. 1 following marking of selected text segment in accordance with one embodiment of the present invention;

FIG. 3 is a flow chart representing a system and method for selecting, marking, and pasting of selected text segment to an application in accordance with one embodiment of the present invention;

FIG. 4 is a diagram representing disambiguation of a selected text segment and pasting of the selected text to fields of an application in accordance with one embodiment of the present invention; and

FIG. 5 is a diagram representing an aspect of the present invention wherein certain processes may be performed as background operations.

### DETAILED DESCRIPTION OF EMBODIMENTS

The term “electronic equipment” as referred to herein includes portable radio communication equipment. The term “portable radio communication equipment”, also referred to herein as a “mobile radio terminal” or “mobile device”, includes all equipment such as mobile phones, pagers, communicators, e.g., electronic organizers, personal digital assistants (PDAs), smart phones or the like.

Many of the elements discussed in this specification, whether referred to as a “system” a “module” a “circuit” or similar, may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

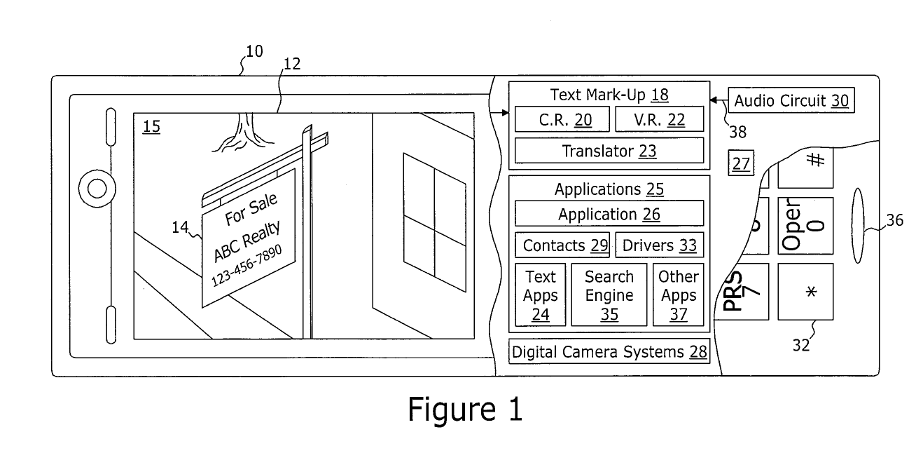

With reference to FIG. 1, an exemplary device 10 may be embodied in a digital camera, mobile telephone, mobile PDA, notebook or laptop computer, television, or other device which may include a display screen 12, a digital camera system 26 (or other means for obtaining a still or motion video image for rendering on the display screen 12), an audio circuit 30 for generating an audio signal representative of spoken words uttered by the user and captured by a microphone 36, and a processor 27 controlling operation of the foregoing as well as executing code embodied in various applications 25.

In general, an application, such as an application 26, drives rendering of a still or motion video digital image 15 on the display screen 12. For purposes of illustrating the present invention, the rendering of the image 15 on the display may comprise any of: i) a real time still or video image output of the camera system 28 such that the display is functioning as a “view finder” for the camera system (no need to store the still or video image); ii) a still digital image or video clip captured by the camera system 28 and stored in volatile memory but not yet stored in the database 31; iii) a still digital image or video clip previously stored in a database 32 managed by the application 26; and/or iv) a still digital image or video clip provided by another source and rendered on the display screen 12. Such other source may be any of: i) a television signal broadcaster providing the image by way of television broadcast ii) a remote device capable of internet communication (email, messaging, file transfer, etc) providing the image by way of any internet communication; or iii) a remote device capable of point to point communication providing the image by way of point to point communication such as blue tooth, near field communication, or other point to point technologies.

In the exemplary embodiment, the digital image 15 may include a depiction of text 14 therein. A text mark-up object 18 (which may be part of an embedded operating system) facilitates the selection, marking, and input or pasting of at least a portion of the depiction of text 14 (as ASCII text or as a pixel depiction of the text) to an application operated by the mobile device 10. Such applications may include i) a text based application 24 (e.g. a notes application, a word processor application, or other similar applications); ii) a photo album application for purposes of either pasting a text tag with the digital image and/or removing the spoken text from a digital image using image touch up techniques, iii) a contact directory 29, iv) a search engine 35, v) a driver 33 to a communication system such that the text is “pasted” to a remote device or an application operating on a remote device by any communication system such as NFC, Blue Tooth, IP connection, etc; or, vi) any other application 37.

In general, the text mark-up object 18 comprises: i) a character recognition system 20 for generating a character string representative of the depiction of text 14; and ii) a voice recognition system 22 for receiving the audio signal 38 from the audio circuit 30 representing spoken words uttered by the user and performing speech recognition to generate a text representation of the spoken words uttered by the user. Further, the text mark-up object 18 may comprise a translator 23 for converting the text representation of the words uttered by the user from a first language (such as Swedish) to a second language (such as English).

In operation, the text mark-up object 18 may determine the selected text segment by selecting text which is both common to both the depiction of text 14 within the image 15 as rendered on the display screen 12 and the text representation of the spoken words uttered by the user.

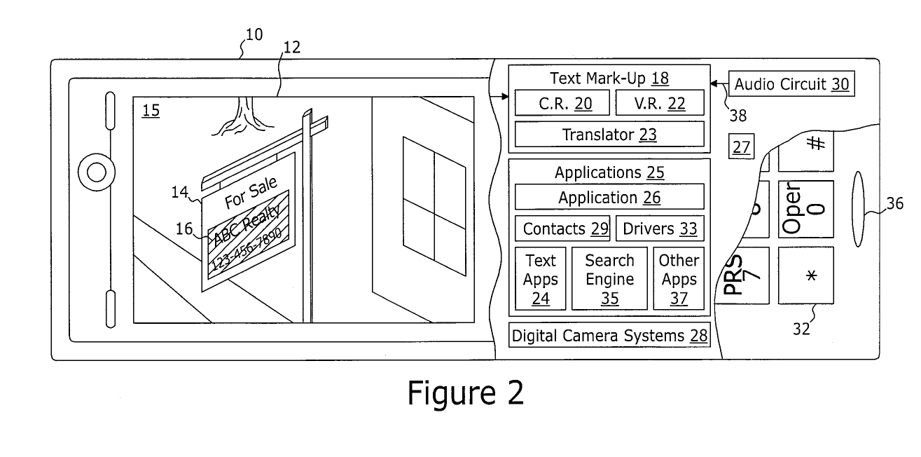

Referring briefly to FIG. 2, the selected text segment may be shown in mark-up 16 such as by showing the text utilizing highlight and/or hatching on the display 12. Further, upon the user initiating an applicable command, the selected text segment shown in mark-up 16 may be input to, or utilized by, one of the applications 25 either as a character string or as a pixel depiction of the text (e.g. image of the text).

For example, upon initiation of an input command (for example, but operation of a button or selecting the text on the display screen utilizing an overlaying touch panel), the selected text segment may be copied (e.g. input) as a character string or a pixel based image of the text a selected one of the applications 25 such as text based application 24, contacts 29, the search engine 35, or one of the other applications 37. Similarly, upon initiation of an applicable command, the selected text segment may be input to one of the drivers 33 for transfer to a remote device (or application on the remote device) by any communication means such as NFC, Bluetooth, or wireless internet. In yet another embodiment, upon initiation of an applicable command, the selected text segment may be utilized by the application 26 rendering the image on the display 15 for purposes of removing such text from the image (e.g. using image processing techniques to remove the text).

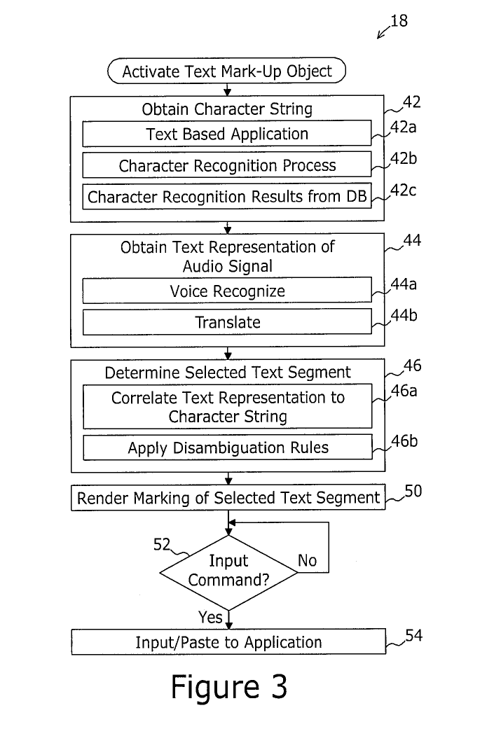

The flow chart of FIG. 3 depicts exemplary steps performed by the text mark-up object 18 for facilitating the selection, marking, and pasting/input of at least a portion of the depiction of text 14 on the display screen 12 to an application 25.

Referring to FIG. 3 in conjunction with FIG. 1, step 40 represents obtaining a character string representation of the depiction of the text 14 rendered on the display 12. In the event that the depiction of the text 14 rendered on the display 12 is generated by another text based application 24, the depiction is available in character string from, and may be obtained from, such text based application 24 as represented by sub step 42a.

If the depiction of the text 14 is included in a digital image 15 or other graphic image, as described above, a character string representative thereof may be obtained by performing a character recognition process 20 on the depiction of the text 14 as represented by sub step 42b.

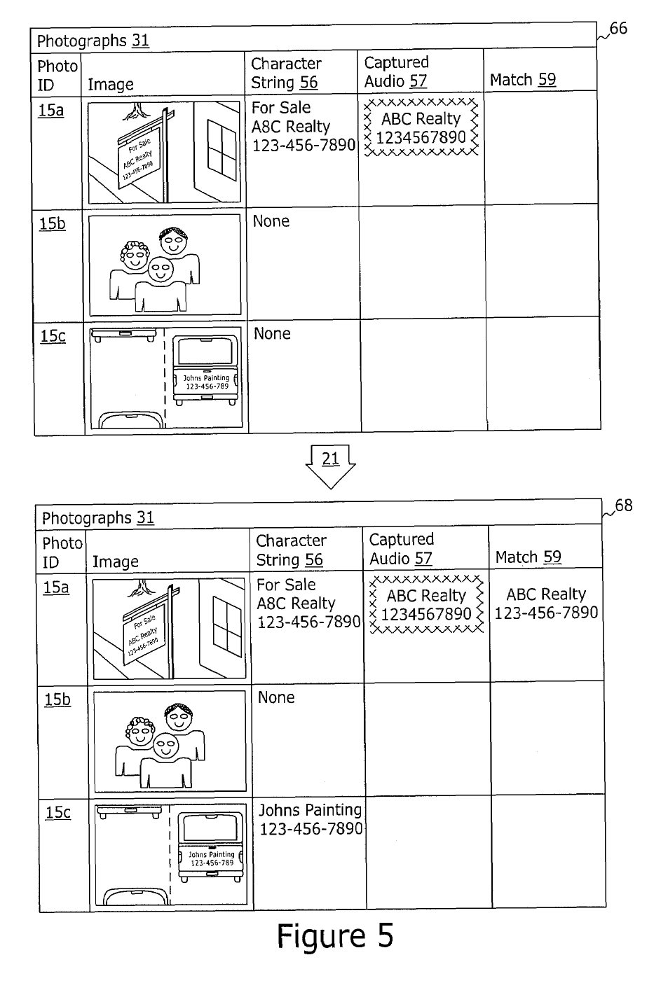

Step 44 represents obtaining a text representation of spoken words uttered by the user. Such step may comprise as represented by sub step 44a: i) coupling the audio signal 38 to a voice recognition system 22 such that the text representation is generated in real time (for example while the user is viewing a captured still or motion video image on the display screen 12 and/or using the display screen 12 as a view finder for the digital camera); or ii) obtaining previously captured audio 57 (discussed with respect to FIG. 5) for input to the voice recognition system 22. Further, step 33 may, as an option, comprise inputting the text representation generated at step 44a to the translator 23 to convert to text of a different language as represented by sub-step 44b.

Step 46 represents determining a selected text segment which, as discussed, is a character string which corresponds to both a portion of the depiction of text 14 rendered on the display screen 12 and the text representation of the spoken words uttered by the user. Determining the selected text segment may comprise correlating the text representation of the spoken words uttered by the user to the character string as represented by sub step 46a and applying disambiguation rules 46b such that differences between the text representation of the spoken words uttered by the user and the character string are resolved in a manner expected to yield the correct character string within the selected text segment.

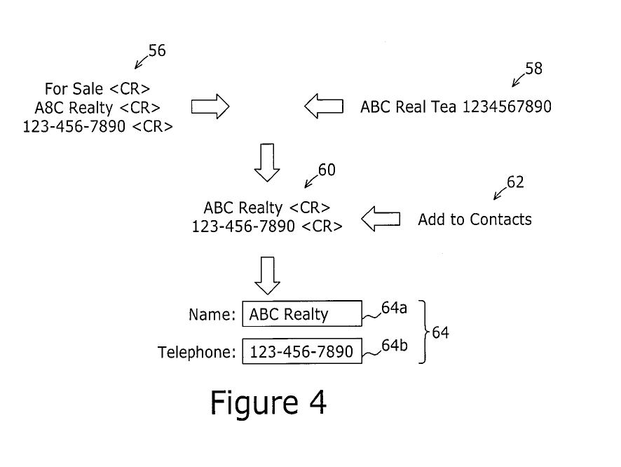

For example, turning briefly to FIG. 4 in conjunction with FIG. 1 and FIG. 3, the character string 56 resulting from application of the character recognition process 20 to the depicted text 14 may comprise: “For Sale<CR> A8C Realty<CR>123-456-7890<CR>. Similarly the text representation of the spoken words uttered by the user 58 resulting from application of the voice recognition process 22 to the audio signal 38 may comprise “ABC Real Tea 123456789”.

Sub step 46a correlating the text representation of the spoken words uttered by the user 58 to the character string 56 is for purposes of selecting only that portion of the depiction of text 14 which the user desires to be included in the selected text segment 60. In this example, the portion of the character string “A8C Realty<CR>123-456-7890<CR> roughly correlates to “ABC Real Tea 1234566890”. The portion of the characters string 56 “For Sale<CR>” which is clearly within the depicted text 14 is not within the text representation of the spoken words uttered by the user 58 (e.g the words For Sale were not uttered by the user) and therefore “For Sale<CR>” is excluded from the selected text segment 60.

Sub step 46b applying disambiguation rules is for purposes of resolving differences between the character string 56 and the text representation of spoken words uttered by the user 58 in a manner expected to yield an accurate character string within the selected text segment 60.

A first rule may require use of the text representation of the spoken words uttered by the user 58 for differences wherein the difference is more ambiguous in the text domain but than in the audio domain. For example, the character of “8” may be readily mis-recognized for the text character of “B” in the text domain—the two characters are quite similar. Therefore, in the text domain a difference between an “8” and a “B” is highly ambiguous. On the other hand, in the audio domain annunciation of the letter “B” is clearly distinct from annunciation of the numeral “8”. Therefore, in the audio domain the difference is much less ambiguous. Therefore, with respect to the difference of the character “B” and “8” between the text representation of the spoken words uttered by the user 58 and the character string 56, application of this rule results in the letter “B” being selected for inclusion in the selected text segment 60.

Similarly, a second rule may require use of the character string 56 for differences wherein the difference is more ambiguous in the audio domain than in text audio domain. For example, the words of “Real Tea” may be readily mis-recognized for the word of “Realty” in the audio domain—annunciation of the two are quite similar. Therefore, in the audio domain a difference between “Real Tea” and “Realty” is highly ambiguous. On the other hand, in the text domain “Real Tea” is more clearly distinct from “Realty”. Therefore, in the text domain the difference is much less ambiguous. Therefore, with respect to the difference of the characters “Real Tea” and “Realty” between the text representation of the spoken words uttered by the user 58 and the character string 56, application of this rule results in the “Realty” being selected for inclusion in the selected text segment 60.

Yet other rules may include: i) inclusion, within the selected text segment 60, of carriage returns “<CR>” present within the character string 56 as carriage returns are indeterminable from a voice recognition process; ii) inclusion, within the selected text segment 60, of silent punctuation such as dashes within a formatted telephone number as such silent punctuation may be indeterminable from a voice recognition process; iii) grammar or context based rules used to disambiguate words based on proper and/or common usage; and/or iv) user specific rules which comprise rules based on the user's past history of text or topics of text marked within images (e.g. learned database of topics).

Step 50 represents rendering a marking 16 to the selected text segment 60 within the depiction of text 14 on the display screen 12 as represented in FIG. 2. As discussed, such marking 16 may be by way of highlight, hatching, or other visible representation.

Following application of marking 16, the system waits for user input of a command which may designate the application to which the selected text segment 60 is to be input. The input/paste command may be by way of: i) the user activating a key 32 which includes a programmed associating with an input function to a certain application; ii) the user activating a touch panel overlaying the display screen by touch; or iii) the user uttering certain words programmed to associate with an input function to a certain application. For example, with reference to FIG. 4, the spoken words “Add to Contacts” 62 may be programmed to initiate a pasting of the selected text segment 60 to a contact directory application 29.

In response to detection of the input/paste command, the text mark-up object 18 may input the selected text segment into an application 25. For example, as represented by FIG. 4, pasting the text into a contact application 29 may include pasting different portions of the selected text segment 60 into different fields 54 of the application 29. For example, “ABC Realty” may be pasted to a contact name field 64a while “123-456-7890”, because of its formatting as a telephone number, may be pasted to a telephone number filed 64b.

Turning briefly to FIG. 5 in conjunction with FIG. 1, in one aspect of the present invention, the depiction of text 14 rendered on the display screen 12 may be part of a digital image 15 previously stored in a database 31 managed by the application 26 and/or a captured audio clip representative of the user identifying the portion of text for marking/pasting may have been previously stored in the database 31.

The database 31 may associate, with each image 15 stored therein: i) the character string 56 resulting from application of the character recognition process 20 to the text 14 depicted within the image 15; and/or ii) an audio clip 57 captured while the image 15 was rendered on the display screen 12.

In this aspect: i) the step of obtaining the character string (step 42 of FIG. 3) may comprise obtaining the character string 56 associated with the image 15 from the database 31 as represented by sub step 42c; and/or ii) the step of obtaining the text representation of the audio signal (step 44 of FIG. 3) may comprise coupling the audio clip 57 from the database 31 to the rather coupling the audio signal 38 to the voice recognition system 22.

A benefit of this aspect is that processing power required for applying character recognition 20 and/or voice recognition 22 is not required at the time that the user is attempting to perform the paste functions. Instead, the character recognition process 20 and/or the voice recognition process 22 may be applied to images 15 stored within the database as a “background” operation 21 when the mobile device is in a state where the processor 27 would otherwise be idle and/or being powered by a line power supply (e.g. recharging).

As depicted in FIG. 5, the background operation 21 character recognition process 20 may, for each image 15 stored in the database 31 that includes a depiction of text 14, and for which a character string representation thereof is not already included in the database 31, apply the character recognition process 20 and write the character string to the database 31 in conjunction with the image 15 for future use in the selection, marking, and pasting of selected text as discussed herein.

For example, at a first point in time 66, the database 31 may includes a plurality of images 15. The images may include: i) a first group of images (represented by image 15a) each of which includes a depiction of text and for which the character recognition process 20 has already generated a character string 56 and included such character string in the database 31; ii) a second group of images (represented by image 15b) which does not include a depiction of text and therefore there exists no character string to associate therewith; and iii) a third group of images (represented by image 15c) which includes a depiction of text and for which the character recognition process 20 has not yet generated a character string 56.

Following the background operation 21 of the character recognition process 22, the character string derived from the depiction of text within the third group is written to the database such that such images become part of the first group (as represented by image 15c).

Similarly, for certain images 15 stored in the database 31 a captured audio clip 57 may be associated therewith. If the image includes a depiction of text 14, and for which text has not been matched with a text representation of an audio signal, the voice recognition process 22, as a background process, may couple generate the text representation of the audio clip 57 and determine the selected text (step 46 of FIG. 3) for storage with the image 15 as match text 59 for use in the selection, marking, and pasting of selected text as discussed herein.

For example, at the first point in time 66, the database 31 may an audio clip in association with image 15a. Following the background operation 21 of the voice recognition process 22, the matched text as discussed with respect to FIG. 4 may be written to the matched text field 59.

Although the invention has been shown and described with respect to certain preferred embodiments, it is obvious that equivalents and modifications will occur to others skilled in the art upon the reading and understanding of the specification. For example, the discussion related to FIG. 5 indicates that the background operation may take place during a time wherein the processor would otherwise be idle. Those skilled in the art recognize that processor activity consumes power and that an alternative, in a power management environment, may include performing the background operation of the character recognition processes only when the mobile device is operating on line power (e.g. charging). The present invention includes all such equivalents and modifications, and is limited only by the scope of the following claims.

1. A device comprising:
a display screen;
an audio circuit for generating an audio signal representing spoken words uttered by the user; and
a processor executing a first application, a second application, and a text mark-up object;
the first application rendering a depiction of text on the display screen;
the text mark-up object:
receiving at least a portion of the audio signal representing spoken words uttered by the user;
performing speech recognition to generate a text representation of the spoken words uttered by the user;
determining a selected text segment, the selected text segment being text which corresponds to both a portion of the depiction of text on the display screen and the text representation of the spoken words uttered by the user; and
performing an input function to input the selected text segment to the second application.

2. The device of claim 1,
the text mark-up object drives rendering of a marking of the portion of the depiction of text on the display screen which corresponds to the selected text segment;
and performs the paste function only upon detection of an input command while rendering the marking of the portion of the depiction of text on the display screen which corresponds to the selected text segment.

3. The device of claim 2, wherein the paste command is an audio command uttered by the user and the text mark-up object detects the command within the audio signal by speech recognition.

4. The device of claim 1, wherein:
the first application is an application rendering a digital image including the depiction of text on the display screen;
the text mark-up object further performs character recognition on the depiction of text to generate a character string; and
and the selected text segment comprises text which corresponds to both a portion of the character string and the text representation of the spoken words uttered by the user.

5. The device of claim 4:
further comprising a digital camera; and
wherein the application renders an image captured by the digital camera as the image including the depiction of text on the display screen.

6. The device of claim 4,
the text mark-up object drives rendering of a marking of the portion of the depiction of text on the display screen which corresponds to the selected text segment;
and performs the paste function only upon detection of an input command while rendering the marking of the portion of the depiction of text on the display screen which corresponds to the selected text segment.

7. The device of claim 6, wherein the paste command is an audio command uttered by the user and the text mark-up object detects the command within the audio signal by speech recognition.

8. The device of claim 1:
further comprising a digital photograph database storing a plurality of images;
the text mark-up object further performs character recognition on text depicted in each image and associates with each image, a character string corresponding to the text depicted therein;
the first application is an application rendering a digital image including the depiction of text on the display screen; and
determining the selected text segment comprising selecting the portion of the character string associated, in the database, with the image rendered on the display screen, which corresponds to the text representation of the spoken words uttered by the user.

9. The device of claim 8,
the text mark-up object drives rendering of a marking of the portion of the depiction of text on the display screen which corresponds to the selected text;
and performs the paste function only upon input of an input command by the user while the rendering of the marking of the portion of the depiction of text on the display screen which corresponds to the selected text segment.

10. The device of claim 9, wherein the paste command is an audio command uttered by the user and the text mark-up object detects the command within the audio signal by speech recognition.

11. The device of claim 1, wherein the selected text segment is text which corresponds to the portion of the depiction of text on the display screen that is between a first text representation of spoken words uttered by the user and a second text representation of spoken words uttered by the user.

12. A method of operating a device to select and paste a selected text segment from a first application to a second application, the method comprising:
driving the first application to render a depiction of text on a display screen;
receiving at least a portion of an audio signal representing spoken words uttered by the user;
performing speech recognition to generate a text representation of the spoken words uttered by the user; and
determining the selected text segment, the selected text segment being text which corresponds to both a portion of the depiction of text on the display screen and the text representation of the spoken words uttered by the user; and
performing an input function to input the selected text segment to the second application.

13. The method of claim 12,
further comprising rendering a marking of the portion of the depiction of text on the display screen which corresponds to the selected text segment;
and performing the paste function only upon detection of an input command while rendering the marking of the portion of the depiction of text on the display screen which corresponds to the selected text segment.

14. The method of claim 13, wherein the paste command is an audio command uttered by the user and recognized within the audio signal.

15. The method of claim 12, wherein:
the first application is an application rendering a digital image including the depiction of text on the display screen;
the text mark-up object further performs character recognition on the depiction of text to generate a character string; and
and the selected text segment comprises text which corresponds to both a portion of the character string and the text representation of the spoken words uttered by the user.

16. The method of claim 15,
further comprising rendering a marking of the portion of the depiction of text on the display screen which corresponds to the selected text segment;
and performing the paste function only upon detection of an input command while rendering the marking of the portion of the depiction of text on the display screen which corresponds to the selected text segment.

17. The method of claim 16, wherein the paste command is an audio command uttered by the user and recognized within the audio signal.

18. The method of claim 12:
the first application is an application rendering a digital image including the depiction of text on the display screen, the digital image being obtained from a database storing a plurality of digital images;
receiving at least a portion of an audio signal representing spoken words uttered by the user;
performing speech recognition to generate a text representation of the words uttered by the user;
determining the selected text segment comprising selecting the portion of the character string associated, in the database, with the image rendered on the display screen, which corresponds to the text representation of the spoken words uttered by the user; and
wherein the characters string associated, in the database, with the image rendered on the display screen is generated and written to the database during a character recognition process operated at time prior to rendering the determining the selected text segment.

19. The method of claim 18,
further comprising rendering a marking of the portion of the depiction of text on the display screen which corresponds to the selected text segment;
and performing the paste function only upon detection of an input command while rendering the marking of the portion of the depiction of text on the display screen which corresponds to the selected text segment.

20. The method of claim 19, wherein the paste command is an audio command uttered by the user and recognized within the audio signal.

21. The method of claim 12, wherein the selected text segment is text which corresponds to the portion of the depiction of text on the display screen that is between a first text representation of spoken words uttered by the user and a second text representation of spoken words uttered by the user.
